(19) United States
(12) Patent Application Publication
(10) Pub. No.: US 2018/0188620 A1
(43) Pub. Date: Jul. 5, 2018

(54) METHOD FOR MANUFACTURING COLOR FILTER SUBSTRATE, COLOR FILTER SUBSTRATE AND DISPLAY PANEL

(71) Applicants: BOE TECHNOLOGY GROUP CO., LTD., Beijing (CN); BEIJING BOE DISPLAY TECHNOLOGY CO., LTD., Beijing (CN)

(72) Inventors: Xiaoguang LI, Beijing (CN); Dong WANG, Beijing (CN); Yu XIAO, Beijing (CN); Nan CHEN, Beijing (CN); Hui ZHANG, Beijing (CN)

(73) Assignees: BOE TECHNOLOGY GROUP CO., LTD., Beijing (CN); BEIJING BOE DISPLAY TECHNOLOGY CO., LTD., Beijing (CN)

(21) Appl. No.: 15/698,033

(22) Filed: Sep. 7, 2017

(30) Foreign Application Priority Data
Jan. 5, 2017 (CN) 201710006938.8

(51) Int. Cl. G02F 1/1362; G02F 1/1335

(52) U.S. Cl. CPC G02F 1/136209; G02F 2001/136222; G02F 1/133617

(57) ABSTRACT

The present disclosure discloses a method for manufacturing a color filter substrate, a color filter substrate, and a display panel. The method includes: forming a black matrix pattern made of a negative photoresist on a base substrate; and forming a color layer on the base substrate where the black matrix pattern is formed, the color layer comprising a color sub-layer made of a positive photoresist.

### CROSS-REFERENCE TO RELATED APPLICATION

The present application claims priority to Chinese Patent Application No. 201710006938.8 filed on Jan. 5, 2017, which is incorporated herein by reference in its entirety.

### TECHNICAL FIELD

The present disclosure relates to a field of display technologies, in particular to a method for manufacturing a color filter substrate, a color filter substrate and a display panel.

### BACKGROUND

Generally, a display panel includes a color filter substrate, an array substrate and a liquid crystal layer formed therebetween. The color filter substrate usually includes a color layer and a black matrix (simply referred to as BM) pattern, wherein the color layer may include a plurality of color sub-layers, different color sub-layers may have different colors, and the black matrix pattern is configured to separate different color sub-layers.

In a method for manufacturing a color filter substrate according to a related art, firstly, a light shielding layer made of a negative photoresist is formed on a base substrate, and the black matrix pattern is obtained by developing the negative photoresist through a mask plate, as shown in FIG. 1-1. Due to a light diffraction, light beams exiting from a gap (with a thickness of 10 μm usually) of the mask plate 01 would diffuse, such that the black matrix pattern 02 formed subsequent to the development has a trapezoid shape as shown in FIG. 1-2. Afterwards, a film layer configured to manufacture the color sub-layer is formed by the negative photoresist on the base substrate where the black matrix pattern is formed, and then the film layer is exposed and developed so as to form the color sub-layer, as shown in FIG. 1-3. The color sub-layer 03 and the black matrix pattern 02 are laminated at an overlapping region, and a height difference caused by this lamination may be referred to as an angular segment difference. In order to eliminate adverse influence of the angular segment difference, it usually needs to form a planarization layer (also known as an over cover, or simply referred to as OC) on the base substrate where the color layer is formed, and increase a thickness of an alignment layer formed on the planarization layer as well.

However, the relatively large amount of materials is consumed by the planarization layer and the alignment layer that are required to eliminate the adverse influence of the angular segment difference.

### SUMMARY

At least one embodiment of the present disclosure provides a method for manufacturing a color filter substrate, a color filter substrate, and a display panel.

According to a first aspect of the present disclosure, there is provided a method for manufacturing a color filter substrate, including: forming a black matrix pattern made of a negative photoresist on a base substrate; and forming a color layer on the base substrate where the black matrix pattern is formed, the color layer comprising a color sub-layer made of a positive photoresist.

Optionally, a preset angle is formed between any side surface of the black matrix pattern and the base substrate. The forming a color layer on the base substrate where the black matrix pattern is formed includes: forming a first film layer made of the positive photoresist on the base substrate where the black matrix pattern is formed; exposing the first film layer through a first mask plate and simultaneously controlling a distance between the first mask plate and the first film layer, such that an angle between a light beam transmitted through an edge of a transparent region on the first mask plate and the base substrate is substantially equal to the preset angle; and developing the first film layer so as to form the color sub-layer.

Optionally, the preset angle satisfies an equation of tan α=D/L, wherein α is the preset angle, D is a distance between the first mask plate and the first film layer, and L is equal to 2 mm.

Optionally, the preset angle satisfies an equation of α=D/L substantially, wherein α is the preset angle, D is a distance between the first mask plate and the first film layer, and L is equal to 2 mm.

Optionally, the forming a black matrix pattern made of a negative photoresist on a base substrate includes: forming a light shielding layer made of the negative photoresist on the base substrate; exposing the light shielding layer through a second mask plate, and simultaneously controlling a distance between the second mask plate and the light shielding layer, such that an angle between a light beam transmitted through an edge of a transparent region on the second mask plate and the base substrate is substantially equal to the preset angle; and developing the light shielding layer so as to form the black matrix pattern.

Optionally, after forming the color layer on the base substrate where the black matrix pattern is formed, the method further includes: forming a common electrode layer and an alignment layer successively on the base substrate where the color layer is formed. Further, the alignment layer formed on the base substrate including no planarization layer has a thickness less than a thickness threshold, the thickness threshold representing a thickness of an alignment layer formed on a base substrate including the planarization layer.

Optionally, after forming the color layer on the base substrate where the black matrix pattern is formed, the method further includes: forming a planarization layer, a common electrode layer and an alignment layer successively on the base substrate where the color layer is formed. Further, the planarization layer has a thickness less than 1.5 μm.

Optionally, the alignment layer is made of polyimide.

According to a second aspect of the present disclosure, there is provided a color filter substrate, including: a base substrate; a black matrix pattern which is located on the base substrate and is made of a negative photoresist; and a color layer located on the base substrate provided with the black matrix pattern, wherein the color layer comprises a color sub-layer made of a positive photoresist.

Optionally, a preset angle is formed between any side surface of the black matrix pattern and the base substrate; the color sub-layer is formed by developing a first film layer after the first film layer is exposed through a first mask plate; the first film layer is arranged on the base substrate and made of the positive photoresist; and a distance between the first mask plate and the first film layer is controlled during exposure of the light shielding layer, such that an angle between a light beam transmitted through an edge of a transparent region on the first mask plate and the base substrate is substantially equal to the preset angle.

Optionally, the preset angle satisfies an equation of tan α=D/L, wherein α is the preset angle, D is a distance between the first mask plate and the first film layer, and L is equal to 2 mm.

Optionally, the preset angle satisfies an equation of α=D/L substantially, wherein α is the preset angle, D is a distance between the first mask plate and the first film layer, and L is equal to 2 mm.

Optionally, the black matrix pattern is formed by developing a light shielding layer after the light shielding layer is exposed through a second mask plate; the light shielding layer is arranged on the base substrate and made of the negative photoresist; and a distance between the second mask plate and the light shielding layer is controlled during exposure of the light shielding layer, such that an angle between a light beam transmitted through an edge of a transparent region on the second mask plate and the base substrate is substantially equal to the preset angle.

Optionally, the color filter substrate further includes a common electrode layer and an alignment layer successively arranged on the base substrate provided with the color filter layer.

Optionally, the alignment layer formed on the base substrate comprising no planarization layer has a thickness less than a thickness threshold, the thickness threshold representing a thickness of an alignment layer formed on a base substrate comprising the planarization layer.

Optionally, the color filter substrate further includes a planarization layer which has a thickness less than 1.5 μm, a common electrode layer and an alignment layer, successively arranged on the base substrate provided with the color filter layer.

Optionally, the alignment layer is made of polyimide.

According to a third aspect of the present disclosure, there is provided a display panel including any above-mentioned color filter substrate according to the second aspect.

### BRIEF DESCRIPTION OF THE DRAWINGS

In order to more clearly explain the technical solutions of the embodiments of the present disclosure, the drawings to be used in the descriptions of the embodiments are briefly introduced as follows. Apparently, the following drawings merely illustrate some embodiments of the present disclosure, and a person skilled in the art can obtain other drawings from these drawings without any creative effort.

FIG. 1-1 is a structural schematic diagram of a base substrate according to the related art;

FIG. 1-2 is a structural schematic diagram of another base substrate according to the related art;

FIG. 1-3 is a structural schematic diagram of another base substrate according to the related art;

FIG. 2 is a flow chart of a method for manufacturing a color filter substrate according to some embodiment of the present disclosure;

FIG. 3-1 is a flow chart of a method for manufacturing a color filter substrate according to some embodiment of the present disclosure;

FIG. 3-2 is a structural schematic diagram of a base substrate according to the embodiment shown in FIG. 3-1;

FIG. 3-3 is a structural schematic diagram of another base substrate according to the embodiment shown in FIG. 3-1;

FIG. 3-4 is a structural schematic diagram of another base substrate according to the embodiment shown in FIG. 3-1;

FIG. 3-5 is a structural schematic diagram of another base substrate according to the embodiment shown in FIG. 3-1;

FIG. 3-6 is a structural schematic diagram of another base substrate according to the embodiment shown in FIG. 3-1;

FIG. 3-7 is a structural schematic diagram of another base substrate according to the embodiment shown in FIG. 3-1;

FIG. 3-8 is a flow chart of the formation of a film layer according to the embodiment shown in FIG. 3-1;

FIG. 3-9 is a flow chart of the formation of another film layer according to the embodiment shown in FIG. 3-1; and

FIG. 3-10 is a structural schematic diagram of another base substrate according to the embodiment shown in FIG. 3-1.

Specific embodiments in this disclosure have been shown by way of examples in the foregoing drawings and are hereinafter described in detail. The figures and written description are not intended to limit the scope of the inventive concepts in any manner. Rather, they are provided to illustrate the inventive concepts to a person skilled in the art by reference to particular embodiments.

### DETAILED DESCRIPTION

In order to make the objects, the technical solutions and the advantages of the present disclosure more apparent, the embodiments of the present disclosure will be described hereinafter in detail in conjunction with the drawings.

FIG. 2 is a flow chart of a method for manufacturing a color filter substrate according to some embodiments of the present disclosure. In the present embodiment, as an illustration, the color filter substrate is manufactured by the method for manufacturing a color filter substrate. The method for manufacturing a color filter substrate may include the following steps.

In step 201, a black matrix pattern made of a negative photoresist is formed on a base substrate.

In step 202, a color layer is formed on the base substrate where the black matrix pattern is formed, wherein the color layer includes color sub-layer made of a positive photoresist.

The negative photoresist would be cured subjected to exposure, and the cured negative photoresist is not dissoluble in a stage of development. Contrary to the negative photoresist, the positive photoresist at a region exposed to the light would be washed away by a developing agent.

In addition, the method for manufacturing a color filter substrate according to some embodiments of the present invention may further include a step of forming other film layer(s) of the color filter substrate, e.g. a step of forming an alignment layer or the like. These steps may refer to the related art, and are not repeated herein.

To sum up, in the method for manufacturing a color filter substrate according to some embodiments of the present disclosure, the color sub-layer is made of the positive photoresist, such that the color sub-layer has an inverted trapezoidal shape, and is complementary to the black matrix pattern made of the negative photoresist. Thus, an angular segment difference formed between the black matrix pattern and the color sub-layer is reduced, and the problem in the related art of the relatively large amount of materials which is consumed by the planarization layer and the alignment layer required to eliminate the adverse influence of the angular segment difference can be solved. There can be obtained an effect that the material consumption amount of the planarization layer and the alignment layer is reduced and the manufacturing cost is lowered.

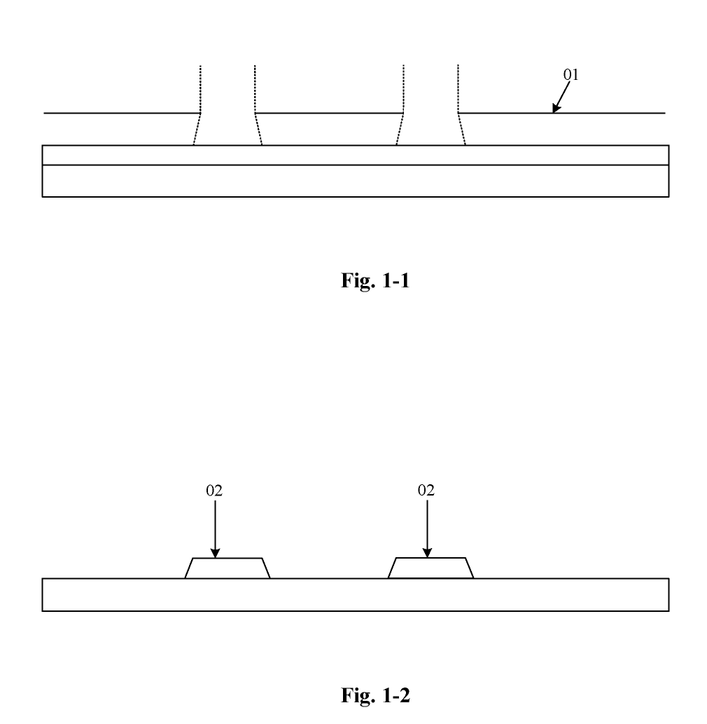

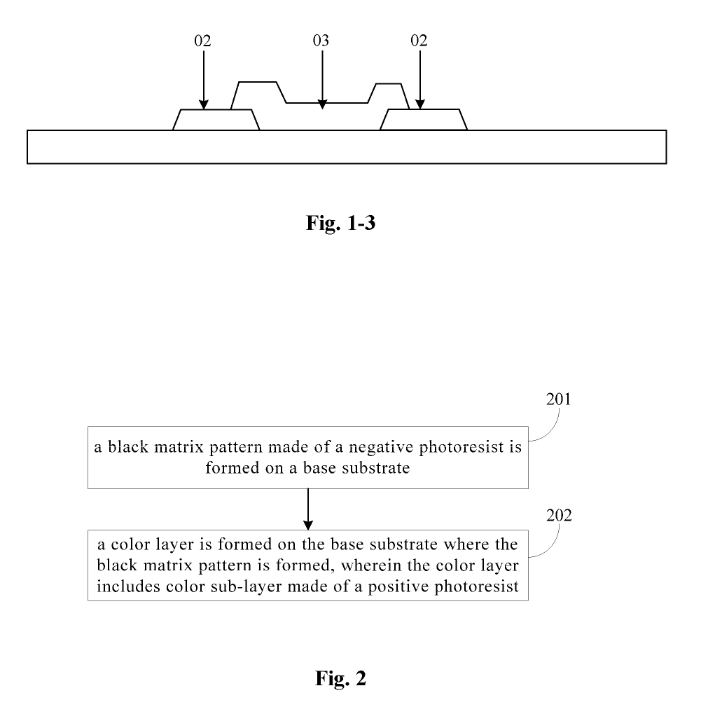

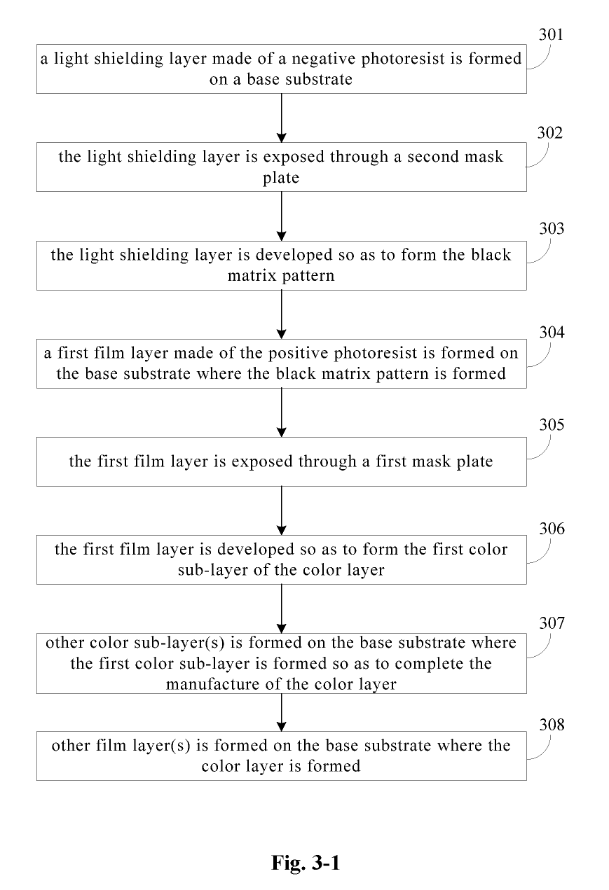

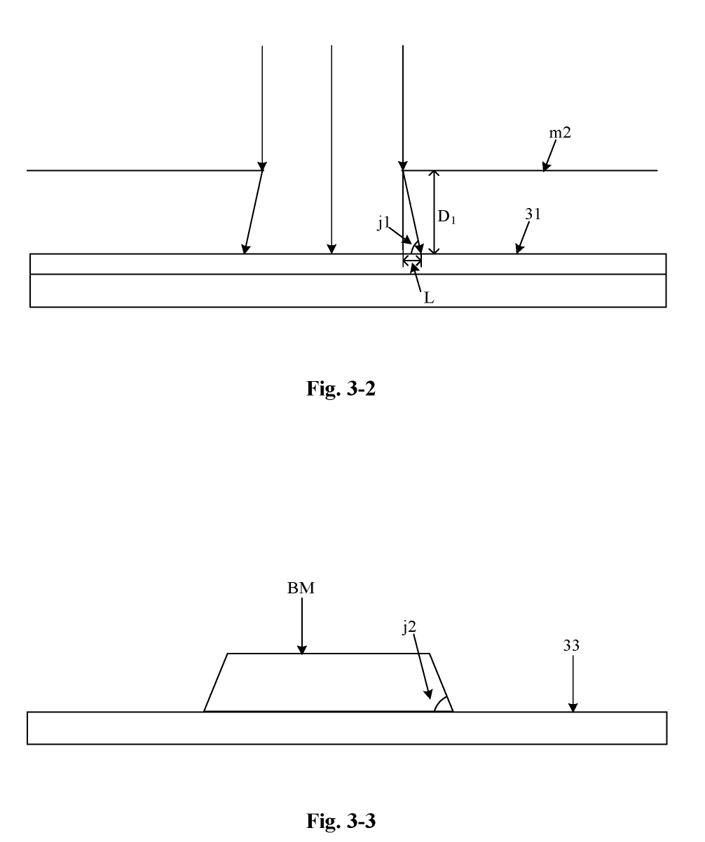

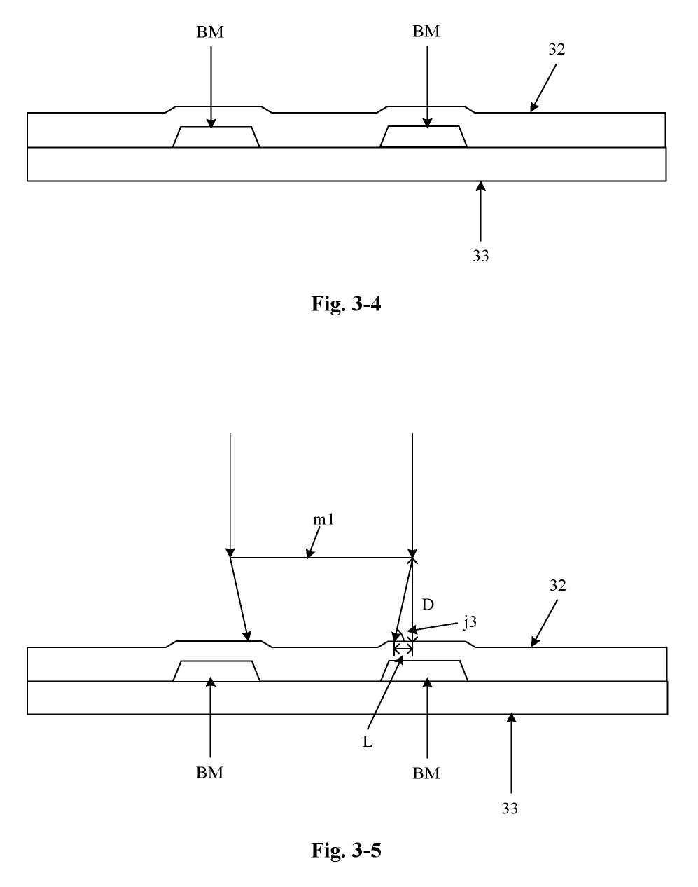

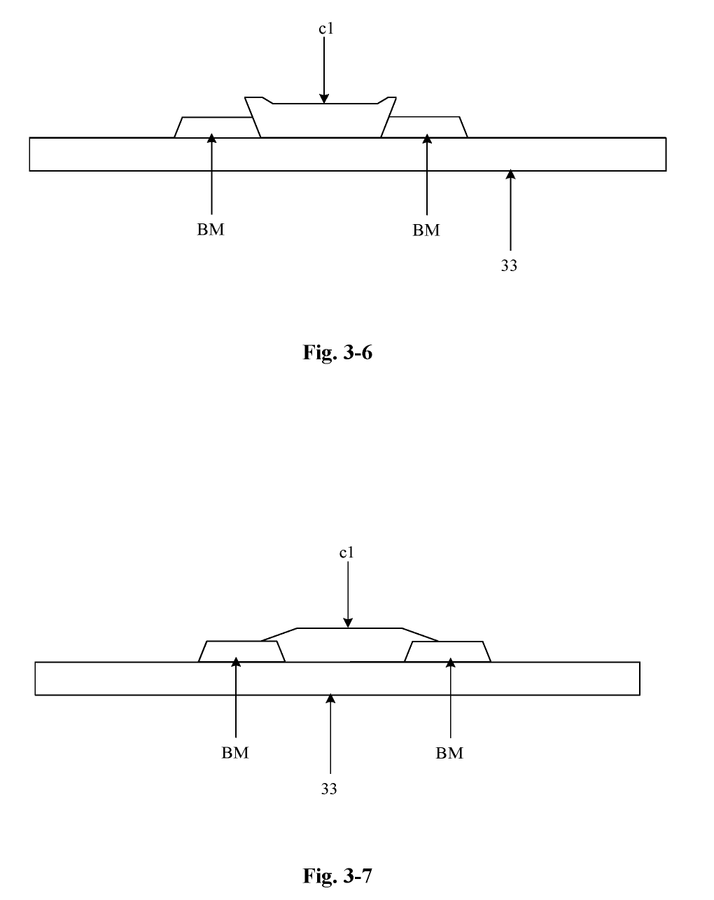

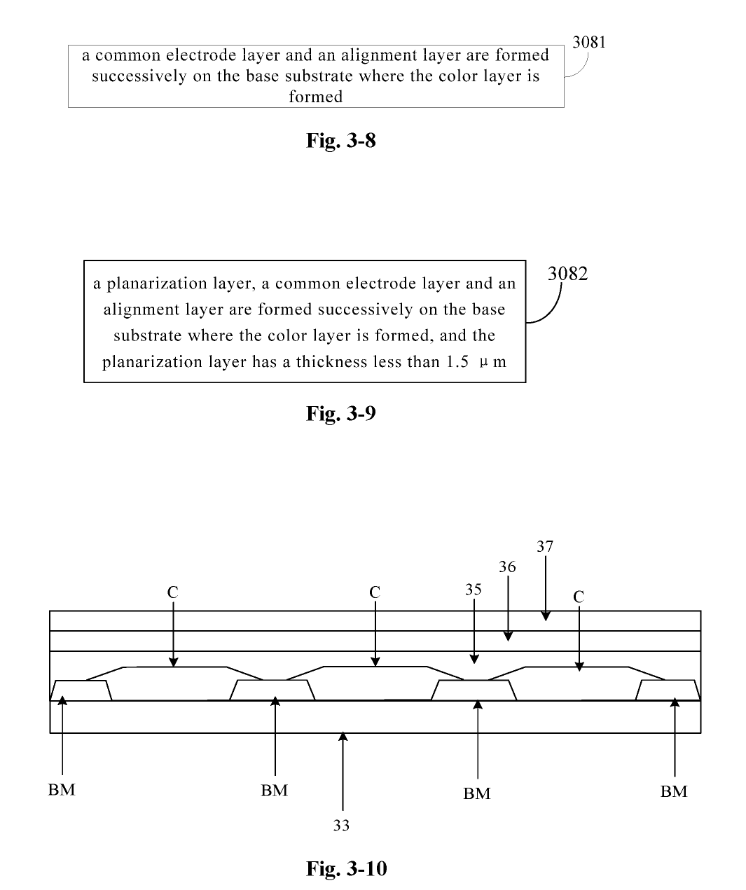

FIG. 3-1 is a flow chart of another method for manufacturing a color filter substrate according to some embodiments of the present disclosure. In the present embodiment, as an illustration, the color filter substrate is manufactured by the method for manufacturing a color filter substrate. The method for manufacturing a color filter substrate may include the following steps.

In step 301, a light shielding layer made of a negative photoresist is formed on a base substrate.

In the case of the adoption of the method for manufacturing a color filter substrate according to some embodiments of the present disclosure, firstly, a light shielding layer made of the negative photoresist may be formed on the base substrate. This light shielding layer may be black and has a thickness of 1.2 μm.

In step 302, the light shielding layer is exposed through a second mask plate.

After being formed on the base substrate, the light shielding layer may be exposed through the second mask plate. The second mask plate may include a transparent region and a nontransparent region. Since the light shielding layer is made of the negative photoresist, the transparent region on the second mask plate may have the same shape as the black matrix pattern. The distance between the second mask plate and the light shielding layer may be controlled when exposing the light shielding layer, such that an angle between the base substrate and a light beam transmitted through an edge of a transparent region on the second mask plate is the preset angle. The preset angle may satisfy an equation of tan α=D1/L, wherein α is the preset angle, D1 is a distance between the second mask plate and the light shielding layer, and L is equal to 2 mm. Since the preset angle α may be very small, tan α may be equal to a approximately, i.e., α=D1/L.

FIG. 3-2 is a schematic diagram showing the light shielding layer 31 being exposed through the second mask plate m2. L is a distance between an orthogonal projection, of the edge of the transparent region of the second mask plate, on the light shielding layer 31 and an irradiation position, of the light beam transmitted through the edge of the transparent region of the second mask plate, on the light shielding layer 31 (this distance may be referred to as a deflection distance and is usually 2 mm). The angle j1 between the base substrate and a light beam transmitted through an edge of a transparent region on the second mask plate m2 is the preset angle α, wherein tan α=D1/L. Since the preset angle α may be very small, tan α may be equal to a approximately.

In some embodiments of the present disclosure, the angle between the base substrate and the side surface of the black matrix pattern formed subsequent to the development may be controlled in this way to be the preset angle.

In step 303, the light shielding layer is developed so as to form the black matrix pattern.

After the second mask plate is exposed, the light shielding layer is developed, so as to form the black matrix pattern. The base substrate having the light shielding layer formed thereon may be washed with the developing agent when exposing the light shielding layer. Since the light shielding layer is made of the negative photoresist, the negative photoresist in a part irradiated by light is not washed away the developing agent, and is reserved to form the black matrix pattern. The base substrate having the black matrix pattern formed thereon may be shown in FIG. 3-3. The angle j2 between the side surface of the black matrix (BM) pattern and the base substrate 33 is the preset angle α.

In some embodiments of the present disclosure, the thicknesses of the black matrix pattern and the color layer may be controlled by a thickness of a coated material, which may refer to the related art, and is not repeated herein.

In step 304, a first film layer made of the positive photoresist is formed on the base substrate where the black matrix pattern is formed.

After the black matrix pattern is formed on the base substrate, the first film layer made of the positive photoresist may be formed on the base substrate where the black matrix pattern is formed. The first film layer is configured to form the first color sub-layer, and thus may be a color film layer. Exemplarily, the first film layer may be a red film layer made of the positive photoresist.

FIG. 3-4 is a structural schematic diagram of the base substrate having the first film layer formed thereon. The first film layer 32 is formed on the base substrate 33 where the black matrix (BM) pattern is formed. At the region where the black matrix pattern is formed, the first film layer 32 slightly protrudes. In addition, the first film layer 32 usually has a thickness larger than that of the black matrix pattern.

In step 305, the first film layer is exposed through a first mask plate.

After being formed on the base substrate, the first film layer may be exposed through the first mask plate. The first mask plate may include a transparent region and a nontransparent region. Since the first film layer is made of the positive photoresist, the nontransparent region on the first mask plate may have the same shape as the first color sub-layer. A structure of the first mask plate may refer to the related art, in which the mask plate configured to form the color sub-layer may also include a transparent region and a nontransparent region. The transparent region of the mask plate may have the same shape as the nontransparent region of the first mask plate, and the nontransparent region of the mask plate may have the same shape as the transparent region of the first mask plate.

As shown in FIG. 3-5, the distance D between the first mask plate m1 and the first film layer 32 is controlled when exposing the first film layer, such that an angle j3 between a light beam transmitted through an edge of a transparent region on the first mask plate m1 and the base substrate 33 is the preset angle, i.e., the angle j3 is equal to the angle between the base substrate 33 and any side surface of the black matrix (BM) pattern. The preset angle satisfies an equation of tan α=D/L, wherein α is the preset angle, D is a distance between the first mask plate m1 and the first film layer 32, and L is a distance between an orthogonal projection, of the edge of the transparent region of the first mask plate, on the first film layer 32 and an irradiation position, of the ray of light transmitting from the edge of the transparent region of the first mask plate, on the first film layer 32, and L is equal to 2 mm. Since the preset angle α may be very small, tan α may be equal to a approximately, that is, α=D/L.

It should be noted that although a certain segment difference exists between a region with the BM layer and a region without the BM layer at the bottom of the first film layer 32, this segment difference is usually relatively small, and can be neglected. The distance between the first mask plate m1 and the first film layer 32 may be the distance between the first mask plate m1 and any position on the first film layer 32.

In step 306, the first film layer is developed so as to form the first color sub-layer of the color layer.

After the first film layer is exposed through the first mask plate, the first film layer may be developed, so as to form the first color sub-layer of the color layer, as shown in FIG. 3-6. Immediately after the first film layer is exposed, two ends of a photoresist in the color sub-layer c1 protrude to some extent. Due to a lack of support below the protrusion and certain flowability of the material used to form the first film layer of the first color sub-layer c1, as shown in FIG. 3-7, this protrusion would fall onto the black matrix (BM) pattern, and each film layer on the entire base substrate has a relatively flat structure. The meanings of other reference numerals in FIGS. 3-6 and 3-7 may refer to FIG. 3-5, and are not repeated herein.

It should be noted that the first color sub-layer may be any color sub-layer of the color layer in the display panel.

In step 307, other color sub-layer(s) is formed on the base substrate where the first color sub-layer is formed so as to complete the manufacture of the color layer.

After the first color sub-layer is formed, other color sub-layer(s) may be formed on the base substrate where the first color sub-layer is formed so as to complete the manufacture of the color layer. The way of forming any other color sub-layer may refer to the way of forming the first color sub-layer according to some embodiments of the present disclosure, or may refer to the way of forming the color sub-layer according to the related art, and is not limited herein. That is, the color layer may include at least one color sub-layer made of the positive photoresist.

In step 308, other film layer(s) is formed on the base substrate where the color layer is formed.

After the color layer is manufactured on the base substrate, other film layer(s) may be formed on the base substrate having the color layer formed thereon.

In some embodiments of the present disclosure, there may exist the following two ways to form other film layer(s).

In a first way, as shown in FIG. 3-8, in substep 3081, a common electrode layer and an alignment layer are formed successively on the base substrate where the color layer is formed.

That is, the common electrode layer and the alignment layer may be formed directly on the base substrate where the color layer is formed, without forming the planarization layer on the base substrate. In the method according to some embodiments of the present disclosure, since the formed color layer is relatively flat, the planarization layer may not be formed, which may save the material of the planarization layer and lower the cost of the display panel. In addition, due to a relatively high flatness of the color layer, the thickness of the alignment layer may also be less than the thickness of the alignment layer in the related art, which saves the material of the alignment layer and further lower the cost of the display panel.

In a second way, as shown in FIG. 3-9, in substep 3082, a planarization layer, a common electrode layer and an alignment layer are formed successively on the base substrate where the color layer is formed, and the planarization layer has a thickness less than 1.5 μm.

That is, the planarization layer, the common electrode layer and the alignment layer may still be formed successively on the base substrate where the color layer is formed, but this planarization layer has a relatively small thickness, less than 1.5 μm (usually 1.5 μm in the related art). In addition, due to a relatively high flatness of the color layer, the thickness of the alignment layer may be less than the thickness of the alignment layer in the related art, which saves the material of the alignment layer and further lowers the cost of the display panel.

FIG. 3-10 is a structural schematic diagram of the base substrate having the color layer C formed thereon after the planarization layer 35, the common electrode layer 36 and the alignment layer 37 are successively formed thereon. The alignment layer 37 may be made of polyimide (simply referred to as PI). The alignment layer 37 is configured to align the liquid crystal layer. In the case that the alignment layer is not flat enough, the alignment of liquid crystal molecules is turbulent, thus in this case, the thickness of the alignment layer is increased in the related art. The common electrode layer 36 may be made of indium tin oxide (simply referred to as ITO), and is configured to apply a voltage to the liquid crystal layer together with a pixel electrode formed on the array substrate. The meanings of other reference numerals in FIG. 3-10 may refer to FIG. 3-5, and are not repeated herein.

It should be noted that after the alignment layer is formed, a photo spacer (simply referred to as PS) may also be formed on the base substrate where the alignment layer is formed, and configured to support the liquid crystal layer, such that the liquid crystal layer has a certain thickness.

To sum up, in the method for manufacturing a color filter substrate according to some embodiments of the present disclosure, the color sub-layer is made of the positive photoresist, such that the color sub-layer has an inverted trapezoidal shape, and is complementary to the black matrix pattern made of the negative photoresist. Thus, an angular segment difference formed between the black matrix pattern and the color sub-layer is reduced, and the problem in the related art of the relatively large amount of materials which is consumed by the planarization layer and the alignment layer required to eliminate the adverse influence of the angular segment difference can be solved. There can be obtained an effect that the material consumption amount of the planarization layer and the alignment layer is reduced and the manufacturing cost is lowered.

In addition, some embodiments of the present disclosure further provide a color filter substrate which may be manufactured by the method according to the embodiment shown in FIG. 3-1. As shown in FIG. 3-10, the color filter substrate includes a base substrate 33.

A black matrix (BM) pattern made of the negative photoresist is arranged on the base substrate 33.

A color layer C is formed on the base substrate 33 provided with the black matrix (BM) pattern, and the color layer C includes a color sub-layer made of a positive photoresist. That is, the color layer C may include at least one color sub-layer made of the positive photoresist.

Optionally, the first color sub-layer in the color layer C is formed by exposing the first film layer through the first mask plate, and then developing the first film layer, wherein the first film layer is arranged on the base substrate provided with the black matrix pattern, and is made of the positive photoresist. The distance between the first mask plate and the first film layer is controlled when exposing the first film layer, such that the angle between a light beam transmitted through an edge of a transparent region on the first mask plate and the base substrate is the preset angle, and the angle between any side surface of the black matrix pattern and the base substrate is the preset angle. The manner of forming the first color sub-layer may refer to the embodiment shown in FIG. 3-1, and is not repeated herein.

Optionally, the preset angle satisfies an equation of tan α=D/L, wherein α is the preset angle, D is the distance between the first mask plate and the first film layer, and L is equal to 2 mm. Since the preset angle α is usually tiny, tan α may be equal to a approximately, that is α=D/L.

Optionally, the black matrix pattern is formed by developing the light shielding layer after the light shielding layer is exposed through the second mask plate, wherein the light shielding layer is arranged on the base substrate and made of the negative photoresist. The distance between the second mask plate and the light shielding layer is controlled when exposing the light shielding layer, such that the included angle between an angle between the base substrate and a light beam transmitted through an edge of a transparent region on the second mask plate is the preset angle. The manner of forming the black matrix pattern may refer to the embodiment shown in FIG. 3-1, and is not repeated herein.

Optionally, the color filter substrate may further include a common electrode layer 36 and an alignment layer 37 arranged successively on the base substrate provided with the color filter layer.

Optionally, the color filter substrate may further include a planarization layer 35, a common electrode layer 36 and an alignment layer 37 successively arranged on the base substrate provided with the color filter layer. The planarization layer may have a thickness less than 1.5 μm.

Optionally, the alignment layer 37 may be made of polyimide.

To sum up, in the color filter substrate according to some embodiments of the present disclosure, the color sub-layer is made of the positive photoresist, such that the color sub-layer has an inverted trapezoidal shape, and is complementary to the black matrix pattern made of the negative photoresist. Thus, an angular segment difference formed between the black matrix pattern and the color sub-layer is reduced, and the problem in the related art of the relatively large amount of materials which is consumed by the planarization layer and the alignment layer required to eliminate the adverse influence of the angular segment difference can be solved. There can be obtained an effect that the material consumption amount of the planarization layer and the alignment layer is reduced and the manufacturing cost is lowered.

In addition, some embodiments of the present disclosure further provide a display panel including the color filter substrate shown in FIG. 3-10. It is understood by a person skilled in the art that all or part of the steps for implementing the above-mentioned embodiments may be performed by hardware, or by instructing related hardware by means of programs. Said programs may be stored in a computer-readable storage medium. The above-mentioned storage medium may be an ROM, a magnetic disk, an optical disc, or the like.

The foregoing merely describes the preferred embodiments of the present disclosure and does not intend to limit the present disclosure. Any modification, equivalent substitution, improvement or the like in accordance with the spirit and principle of the present disclosure shall fall within the protection scope of the present disclosure.

What is claimed is:

1. A method for manufacturing a color filter substrate, comprising:
forming a black matrix pattern made of a negative photoresist on a base substrate; and
forming a color layer on the base substrate where the black matrix pattern is formed, the color layer comprising a color sub-layer made of a positive photoresist.

2. The method according to claim 1, wherein α preset angle is formed between any side surface of the black matrix pattern and the base substrate, and
the forming a color layer on the base substrate where the black matrix pattern is formed comprises:
forming a first film layer made of the positive photoresist on the base substrate where the black matrix pattern is formed; exposing the first film layer through a first mask plate and simultaneously controlling a distance between the first mask plate and the first film layer, such that an angle between a light beam transmitted through an edge of a transparent region on the first mask plate and the base substrate is substantially equal to the preset angle; and developing the first film layer so as to form the color sub-layer.

3. The method according to claim 2, wherein the preset angle satisfies an equation of tan α=D/L, wherein α is the preset angle, D is a distance between the first mask plate and the first film layer, and L is equal to 2 mm.

4. The method according to claim 2, wherein the preset angle satisfies an equation of α=D/L substantially, wherein α is the preset angle, D is a distance between the first mask plate and the first film layer, and L is equal to 2 mm.

5. The method according to claim 2, wherein the forming a black matrix pattern made of a negative photoresist on a base substrate comprises:
forming a light shielding layer made of the negative photoresist on the base substrate;
exposing the light shielding layer through a second mask plate, and simultaneously controlling a distance between the second mask plate and the light shielding layer, such that an angle between a light beam transmitted through an edge of a transparent region on the second mask plate and the base substrate is substantially equal to the preset angle; and
developing the light shielding layer so as to form the black matrix pattern.

6. The method according to claim 1, wherein after forming the color layer on the base substrate where the black matrix pattern is formed, the method further comprises:
forming a common electrode layer and an alignment layer successively on the base substrate where the color layer is formed.

7. The method according to claim 6, wherein the alignment layer formed on the base substrate comprising no planarization layer has a thickness less than a thickness threshold, the thickness threshold representing a thickness of an alignment layer formed on a base substrate comprising the planarization layer.

8. The method according to claim 1, wherein after forming the color layer on the base substrate where the black matrix pattern is formed, the method further comprises:
forming a planarization layer, a common electrode layer and an alignment layer successively on the base substrate where the color layer is formed.

9. The method according to claim 1, wherein the planarization layer has a thickness less than 1.5 μm.

10. The method according to claim 6, wherein the alignment layer is made of polyimide.

11. A color filter substrate, comprising:
a base substrate;
a black matrix pattern which is located on the base substrate and is made of a negative photoresist; and
a color layer located on the base substrate provided with the black matrix pattern, wherein the color layer comprises a color sub-layer made of a positive photoresist.

12. The color filter substrate according to claim 11, wherein a preset angle is formed between any side surface of the black matrix pattern and the base substrate; the color sub-layer is formed by developing a first film layer after the first film layer is exposed through a first mask plate; the first film layer is arranged on the base substrate and made of the positive photoresist; and a distance between the first mask plate and the first film layer is controlled during exposure of the light shielding layer, such that an angle between a light beam transmitted through an edge of a transparent region on the first mask plate and the base substrate is substantially equal to the preset angle.

13. The color filter substrate according to claim 12, wherein the preset angle satisfies an equation of tan α=D/L, wherein α is the preset angle, D is a distance between the first mask plate and the first film layer, and L is equal to 2 mm.

14. The color filter substrate according to claim 12, wherein the preset angle satisfies an equation of α=D/L substantially, wherein α is the preset angle, D is a distance between the first mask plate and the first film layer, and L is equal to 2 mm.

15. The color filter substrate according to claim 12, wherein the black matrix pattern is formed by developing a light shielding layer after the light shielding layer is exposed through a second mask plate; the light shielding layer is arranged on the base substrate and made of the negative photoresist; and a distance between the second mask plate and the light shielding layer is controlled during exposure of the light shielding layer, such that an angle between a light beam transmitted through an edge of a transparent region on the second mask plate and the base substrate is substantially equal to the preset angle.

16. The color filter substrate according to claim 11, wherein the color filter substrate further comprises:
a common electrode layer and an alignment layer successively arranged on the base substrate provided with the color filter layer.

17. The color filter substrate according to claim 16, wherein the alignment layer formed on the base substrate comprising no planarization layer has a thickness less than a thickness threshold, the thickness threshold representing a thickness of an alignment layer formed on a base substrate comprising the planarization layer.

18. The color filter substrate according to claim 11, wherein the color filter substrate further comprises:
a planarization layer which has a thickness less than 1.5 μm, a common electrode layer and an alignment layer, successively arranged on the base substrate provided with the color filter layer.

19. The color filter substrate according to claim 16, wherein the alignment layer is made of polyimide.

20. A display panel, comprising the color filter substrate according to claim 11.
